(19) United States
(12) Patent Application Publication
(10) Pub. No.: US 2011/0042547 A1
(43) Pub. Date: Feb. 24, 2011

(54) TERMINAL FOR VIBRATION MOTOR

(76) Inventor: Hyun Gi YANG, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/570,850

(22) Filed: Sep. 30, 2009

(30) Foreign Application Priority Data
Aug. 21, 2009 (KR) 10-2009-0077575

(51) Int. Cl. F16M 13/00

(52) U.S. Cl. 248/677

(57) ABSTRACT

Disclosed herein is a terminal for a vibration motor. The terminal includes a mounting part secured to a first side of a motor body having at a second side thereof a rotating shaft. A first extension part is bent from the lower end of the mounting part in such a way as to extend towards the rotating shaft. A bent part is connected at a front end thereof to a front end of the first extension part, is bent along a side edge in such a way that the bent part overlaps the first extension part, and extends towards the first side of the motor body. A second extension part is bent from the rear end of the bent part in such a way as to extend downwards. A curved part is curved upwards from the rear end of the second extension part.

### CROSS REFERENCE TO RELATED APPLICATION(S)

This application claims the benefit of Korean Patent Application No. 10-2009-0077575, filed on Aug. 21, 2009, entitled “Terminal for vibration motor”, which is hereby incorporated by reference in its entirety into this application.

### BACKGROUND OF THE INVENTION

1. Technical Field

The present invention relates to a terminal for a vibration motor.

2. Description of the Related Art

Generally, a terminal for a vibration motor is an electric device which is mounted to a vibration motor installed in a mobile phone or the like to be used as a vibration generating source, and contacts a circuit board for controlling the operation of the vibration motor so that a predetermined drive power can be transmitted from the circuit board to the vibration motor.

FIG. 1 illustrates a vibration motor having a terminal 16 for a vibration motor according to a first related art.

As shown in FIG. 1, the terminal 16 for the vibration motor according to the first related art is secured to one end of a motor body 11 which has at the other end a rotating shaft 12 coupled to a weight 13, and extends obliquely to be connected to an electric contact 15 of a circuit board 14.

However, the conventional terminal 16 for the vibration motor is problematic in that it obliquely supports the vibration motor on the circuit board 14, so that the vibration motor is unstably supported in terms of the balance of weight. Especially, when a pressing force is applied to the vibration motor in the direction of an arrow, the terminal 16 for the vibration motor may be undesirably removed from the electric contact 15 of the circuit board 14.

In order to solve the problem, a terminal 16′ for a vibration motor according to a second related art has been proposed, which is illustrated in FIG. 2.

As shown in FIG. 2, the terminal 16′ for the vibration motor according to the second related art includes a mounting part 16a, a first part 16b, a second part 16c, a third part 16d and a curved part 16e. The mounting part 16a is secured to one end of a motor to body 11 which has at the other end a rotating shaft 12 coupled to a weight 13. The first part 16b extends from the lower end of the mounting part 16a towards the rotating shaft 12. The second part 16c extends from the front end of the first part 16b through a U-shaped bent part A in such a way as to be parallel to the first part 16b. The third part 16d is bent from the rear end of the second part 16c in such a way as to protrude outwards. The curved part 16e is formed on the rear end of the third part 16d and curved in such a way as to be connected to an electric contact 15 of a circuit board 14.

As shown in FIG. 3, the terminal 16′ for the vibration motor according to the second related art constructed as described above is manufactured through the following method. That is, a panel material is cut to form a unit terminal material M1 having the shape of a rectangle which is long in a length direction. The unit terminal material M1 is bent several times in a length direction, so that the terminal 16′ is obtained.

However, the conventional terminal 16′ for the vibration motor according to the second related art is problematic in that it is manufactured by bending the unit terminal material M1 several times in the length direction, so that the length of the unit terminal material M1 must be long, and a lot of parts may be wasted when the panel material is cut to make the unit terminal material M1.

As shown in FIG. 4, in the case where the panel material having width A and length B is cut to form the unit terminal material M1, only one unit terminal material M1 is formed in the direction of length B of the panel material because the unit terminal material M1 has length L, so that a considerable part of the panel material is wasted.

[First Related art] Japanese Patent Publication No. 11-136901

[Second Related art] Japanese Patent Publication No. 2001-037150

### SUMMARY OF THE INVENTION

The present invention is intended to provide a terminal for a vibration motor, which is capable of reducing the cost of materials and ensuring the reliability of connection.

Further, the present invention is intended to provide a terminal for a vibration motor, which is capable of minimizing plastic deformation.

In an exemplary terminal for a vibration motor according to an embodiment of the present invention, a mounting part is secured to a first side of a motor body having at a second side thereof a rotating shaft. A first extension part is bent from the lower end of the mounting part in such a way as to extend towards the rotating shaft. A bent part is connected at a front end thereof to a front end of the first extension part, is bent along a side edge in such a way that the bent part overlaps the first extension part, and extends towards the first side of the motor body. A second extension part is bent from the rear end of the bent part in such a way as to extend downwards. A curved part is curved upwards from the rear end of the second extension part.

A portion of the bent part may maintain contact with the first extension part.

The rear end of the bent part, the second extension part and the curved part may be separated from the first extension part.

Further, the second extension part may be bent two or more times and extended.

The second extension part may include a first bent extension part which is bent from the rear end of the bent part in such a way as to extend downwards in a vertical direction, and a second bent extension part which is bent from the rear end of the first bent extension part and extends towards the first side of the motor body in such a way as to be inclined downwards.

Further, the second extension part may include a first bent extension part which is bent from a rear end of the bent part in such a way as to extend downwards in a vertical direction, a second bent extension part which extends from a rear end of the first bent extension part towards the first side of the motor body in such a way as to be parallel to the first extension part, and a third bent extension part which extends from a rear end of the second bent extension part towards the first side of the motor body in such a way as to be inclined downwards.

Furthermore, the second extension part may include a first bent extension part which extends from a rear end of the bent part towards the first side of the motor body in such a way as to be inclined downwards, a second bent extension part which extends from a rear end of the first bent extension part towards the first side of the motor body in such a way as to be parallel to the first extension part, and a third bent extension part which extends from a rear end of the second bent extension part towards the first side of the motor body in such a way as to be inclined downwards at an inclination angle which is different from that of the first bent extension part.

### BRIEF DESCRIPTION OF THE DRAWINGS

FIG. 1 is a sectional view illustrating a vibration motor having a terminal for a vibration motor according to a first prior art;

FIG. 2 is a sectional view illustrating a vibration motor having a terminal for a vibration motor according to a second prior art;

FIG. 3 is perspective views illustrating the process of manufacturing the terminal for the vibration motor of FIG. 2 in stages;

FIG. 4 is a view illustrating the formation of unit terminal materials from a panel material which is used to manufacture the conventional terminal for the vibration motor;

FIG. 5 is a schematic sectional view illustrating a vibration motor equipped with a terminal for a vibration motor according to a preferred embodiment of the present invention;

FIG. 6 is perspective views illustrating the process of manufacturing the terminal for the vibration motor according to a preferred embodiment of the present invention in stages;

FIG. 7 is a view illustrating the formation of unit terminal materials from a panel material which is used to manufacture the terminal for the vibration motor; and

FIG. 8 is views illustrating modifications of the terminal for the vibration motor of FIG. 6.

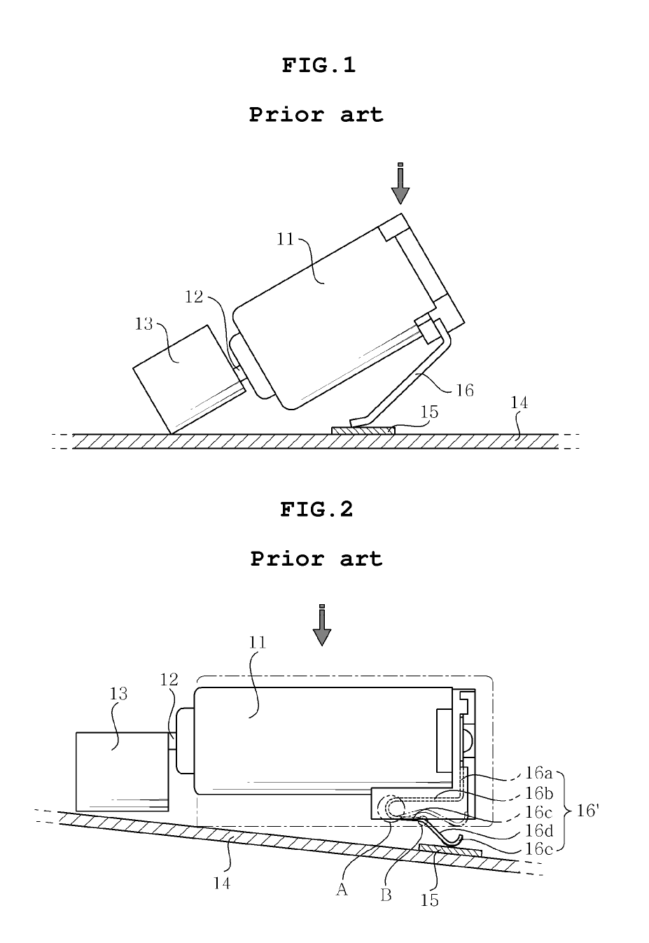

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the terms to describe most appropriately the best method he or she knows for carrying out the invention.

The above and other objects, features and advantages of the present invention will be more clearly understood from the following detailed description taken in conjunction with the accompanying drawings. Herein, the same reference numerals are used throughout the different drawings to designate the same components. Further, when it is determined that the detailed description of the known art related to the present invention might obscure the gist of the present invention, the detailed description thereof will be omitted.

Hereinafter, the preferred embodiments of the present invention will be described in detail with reference to the accompanying drawings.

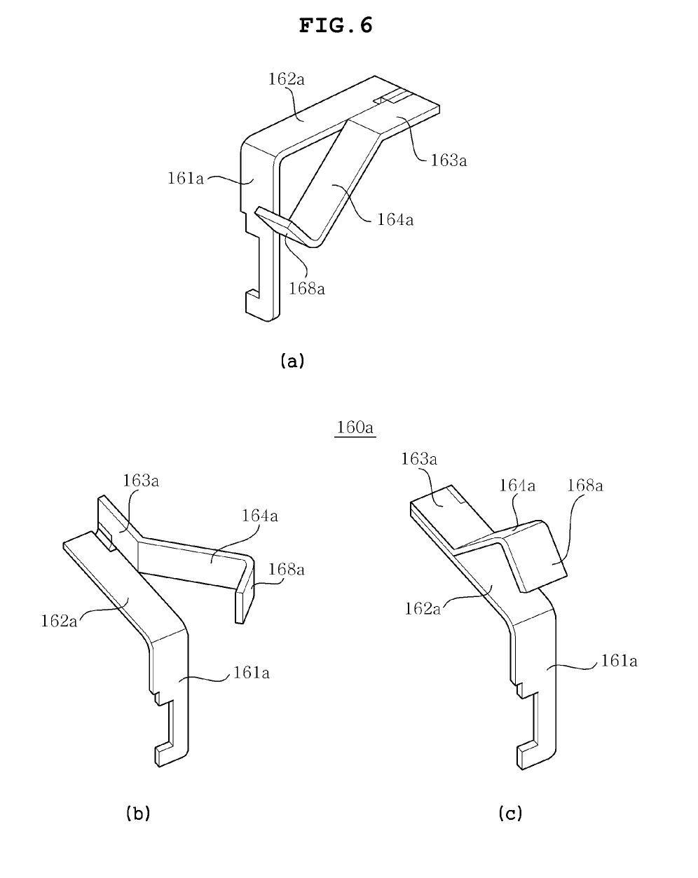

FIG. 5 is a schematic sectional view illustrating a vibration motor equipped with a terminal for a vibration motor according to a preferred embodiment of the present invention. The structure of the vibration motor will be described with reference to FIG. 5.

As shown in FIG. 5, the vibration motor includes a rotating shaft 120, a motor body 110, and a terminal 160 for a vibration motor. A weight 130 is eccentrically secured to a front end of the rotating shaft 120. The motor body 110 is provided with a stator having a brush, a cylindrical coil, and a magnet therein. The terminal 160 is in contact with the electric contact 150 of the circuit board 140 to apply power to the motor body 110.

Such a vibration motor is operated through the following method. That is, when power is supplied to the cylindrical coil by the terminal 160 for the vibration motor, the rotating shaft 120 connected to the stator is rotated by interaction between an electric field generated by the cylindrical coil and a magnetic field generated by the magnet. As the rotating shaft 120 rotates, the weight 130 eccentrically secured to the rotating shaft 120 rotates, so that the motor body 110 vibrates.

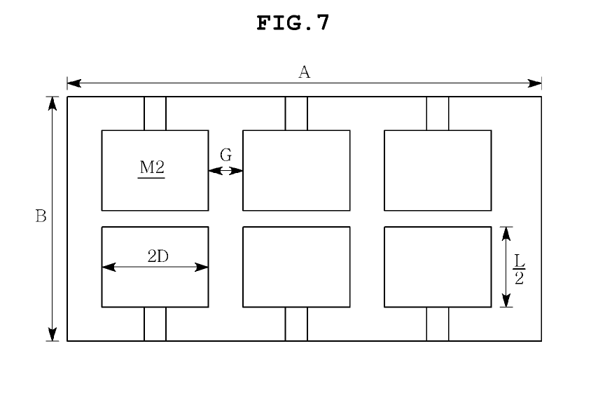

Here, the terminal 160 for the vibration motor is formed by bending a thin unit terminal material to have an elastic force, so that the contact of the terminal 160 with the circuit board 140 is maintained by elastic pressure. The present invention proposes the terminal 160 for the vibration motor, in which a unit terminal material M2 which is long in width 2D is bent laterally, thus reducing the cost of materials. The detailed construction of the terminal 160 for the vibration motor will be described with reference to FIGS. 6 and 7.

FIG. 6 is perspective views illustrating the process of manufacturing the terminal for the vibration motor according to the preferred embodiment of the present invention in stages. Hereinafter, the structure and manufacturing process of the terminal 160a for the to vibration motor according to this embodiment will be described with reference to the drawing.

As shown in FIG. 6, the terminal 160a for the vibration motor according to this embodiment includes a mounting part 161a, a first extension part 162a, a bent part 163a, a second extension part 164a, and a curved part 168a. The mounting part 161a is secured at its upper end to the first side of the motor body 110 having at the second side the rotating shaft 120, that is, to a power terminal through soldering in such a way as to extend downwards. The first extension part 162a is bent to extend from the lower end of the mounting part 161a towards the rotating shaft 120. The bent part 163a is bent from the side of the first extension part 162a to overlap the first extension part 162a while the front end of the bent part 163a is connected to the front end of the first extension part 162a, and extends towards the first side of the motor body 110. The second extension part 164a is bent in such a way as to extend downwards from the rear end of the bent part 163a. The curved part 168a extends from the rear end of the second extension part 164a in such a way as to be curved upwards.

The terminal 160a for the vibration motor constructed as described above is manufactured as follows. That is, a unit terminal material M2 which is larger in width than conventional unit terminal material is cut in a length direction except for part of the upper end of the unit terminal material M2. Subsequently, the first part of the cut unit terminal material M2 is bent to form the mounting part 161a and the first extension part 162a. The second part of the cut unit terminal material M2 is bent to form the bent part 163a, the second extension part 164a, and the curved part 168a (see FIG. 6(a)). Next, the second part is folded towards the first part using a coupled portion between the first and second parts (see FIG. 6(b)). Thereby, the terminal 160a for the vibration motor, which is constructed so that the second part overlaps the first part, is manufactured. That is, the front end of the first extension part 162a and the front end of the bent part 163a are connected to each other at side edges thereof, and the bent part 163a extends while overlapping the first extension part 162a. Here, since the rear end of the bent part 163a is cut off from the first extension part 162a, the bent part 163a is separated from the first extension part 162a.

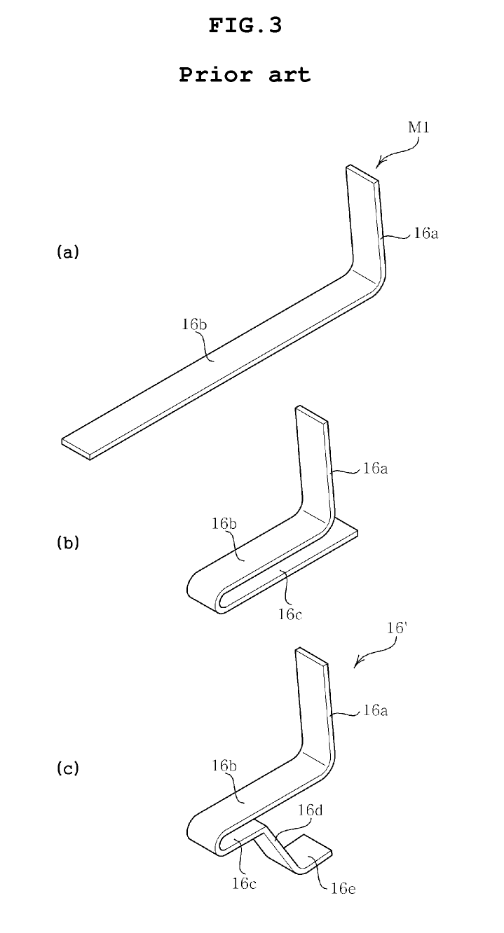

As such, when the terminal 160a for the vibration motor manufactured by vertically cutting part of the unit terminal material M2 which is long in width and bending the cut unit terminal material M2 laterally is compared with the terminal 16′ for the vibration motor manufactured through the method of FIG. 3, the cost of materials is reduced. The reason will be described with reference to FIG. 7 which illustrates the formation of unit terminal materials from the panel material which is used to manufacture the terminal for the vibration motor.

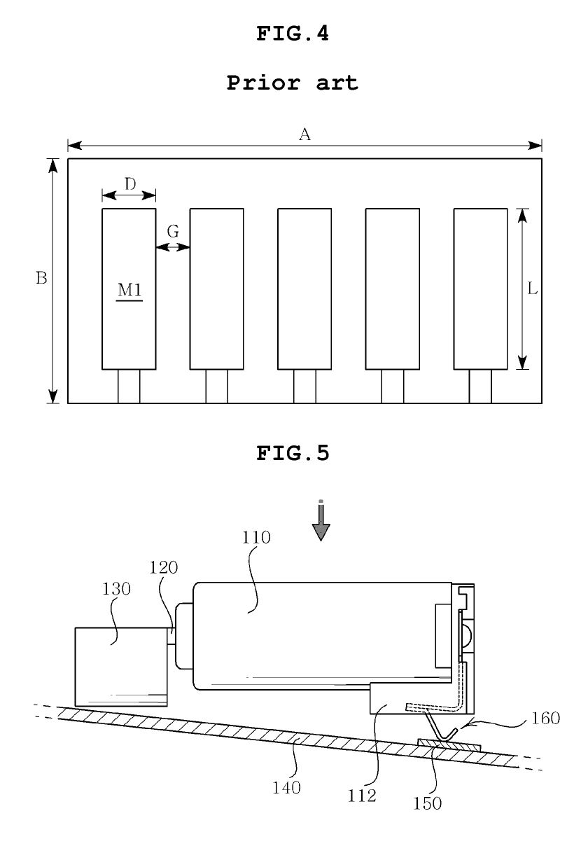

As shown in FIG. 7, when a plurality of unit terminal materials M2, having width 2D which is twice as long as the width of a conventional unit terminal material M1 and having length L/2 which is a half as long as the length of the conventional unit terminal material M1, is formed at regular intervals G using the panel material having width A and length B, unit terminal materials M2 which are one more than those of FIG. 4 can be formed, so that the cost of materials is reduced. That is, when the terminal 160a for the vibration motor capable of ensuring the reliability of connection is manufactured, the cost of materials can be reduced by changing a bending direction.

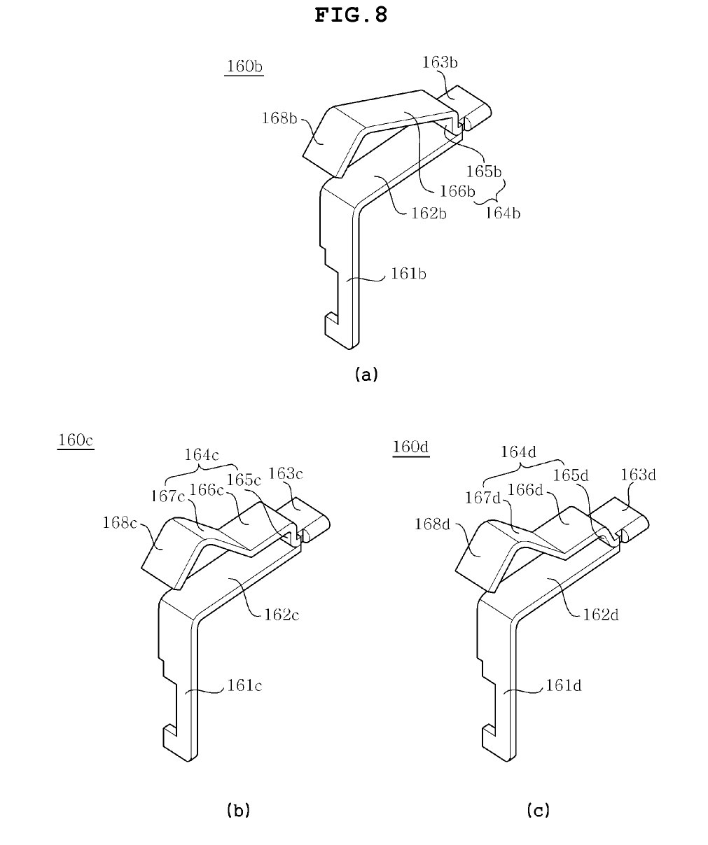

FIG. 8 is views illustrating modifications of the terminal for the vibration motor of FIG. 6. Herein below, constructions of terminals 160b, 160c, and 160d for vibration motors will be described in detail with reference to FIG. 8.

First, as shown in FIG. 8(a), the terminal 160b for the vibration motor includes a mounting part 161b, a first extension part 162b, a bent part 163b, a second extension part 164b which is bent two or more times, and a curved part 168b. The second extension part 162b includes a first bent extension part 165b and a second bent extension part 166b. The first bent extension part 165b is bent from the rear end of the bent part 163b in such a way as to extend downwards in a vertical direction. The second bent extension part 166b is bent and extends from the rear end of the first bent extension part 165b to the first side of the motor body 110 in such a way as to be inclined downwards.

Next, as shown in FIG. 8(b), the terminal 160c for the vibration motor includes a mounting part 161c, a first extension part 162c, a bent part 163c, a second extension part 164c which is bent two or more times, and a curved part 168c. The second extension part 164c includes a first bent extension part 165c, a second bent extension part 166c, and a third bent extension part 167c. The first bent extension part 165c is bent from the rear end of the bent part 163c in such a way as to extend downwards in a vertical direction. The second bent extension part 166c is bent from the rear end of the first bent extension part 165c and extends towards the first side of the motor body 110 in such a way as to be parallel to the first extension part 162c. The third bent extension part 167c is bent and extends from the rear end of the second bent extension part 166c to the first side of the motor body 110 in such a way as to be inclined downwards.

Further, as shown in FIG. 8(c), the terminal 160d for the vibration motor includes a mounting part 161d, a first extension part 162d, a bent part 163d, a second extension part 164d which is bent two or more times, and a curved part 168d. The second extension part 164d includes a first bent extension part 165d, a second bent extension part 166d, and a third bent extension part 167d. The first bent extension part 165d is bent and extends from the rear end of the bent part 163d towards the first side of the motor body 110 in such a way as to be inclined downwards. The second bent extension part 166d extends from the rear end of the first bent extension part 165d towards the first side of the motor body 110 in such a way as to be parallel to the first extension part 162d. The third bent extension part 167d extends from the rear end of the second bent extension part 166d at an inclination angle which is different from that of the first bent extension part 165d and is bent towards the first side of the motor body 110 in such a way as to be inclined downwards.

That is, according to the present invention, the second extension part 164b, 164c, or 164d has two or more bent parts. Thus, when pressing force is applied to the terminal, the pressing force is dispersed, thus minimizing the plastic deformation of the terminal 160b, 160c, or 160d for the vibration motor.

Meanwhile, since the terminals for vibration motors shown in FIG. 8 are merely illustrative, it is apparent that the bent angle and number of the second extension part 164b, 164c, or 164d may be changed.

As described above, the present invention provides a terminal for a vibration motor, which is manufactured by cutting part of a unit terminal material which is long in width, in a length direction, and bending the unit terminal material laterally, so that a plurality of unit terminal materials can be formed from a panel material, thus reducing the cost of materials in comparison with a conventional terminal, and ensuring the reliability of connection.

Further, the present invention provides a terminal for a vibration motor, in which a second extension part is bent two or more times, thus allowing stress applied to the terminal to be dispersed, therefore minimizing the plastic deformation of the terminal for the vibration motor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood as falling within the scope of the present invention.

What is claimed is:

1. A terminal for a vibration motor, comprising:
a mounting part secured to a first side of a motor body having at a second side thereof a rotating shaft;
a first extension part bent from a lower end of the mounting part in such a way as to extend towards the rotating shaft;
a bent part connected at a front end thereof to a front end of the first extension part, bent along a side edge in such a way that the bent part overlaps the first extension part, and extending towards the first side of the motor body;
a second extension part bent from a rear end of the bent part in such a way as to extend downwards; and
a curved part curved upwards from a rear end of the second extension part.

2. The terminal as set forth in claim 1, wherein a portion of the bent part maintains contact with the first extension part.

3. The terminal as set forth in claim 1, wherein the rear end of the bent part, the second extension part and the curved part are separated from the first extension part.

4. The terminal as set forth in claim 1, wherein the second extension part is bent two or more times and extended.

5. The terminal as set forth in claim 1, wherein the second extension part comprises:
a first bent extension part bent from the rear end of the bent part in such a way as to extend downwards in a vertical direction; and
a second bent extension part bent from the rear end of the first bent extension part and extending towards the first side of the motor body in such a way as to be inclined downwards.

6. The terminal as set forth in claim 1, wherein the second extension part comprises:
a first bent extension part bent from a rear end of the bent part in such a way as to extend downwards in a vertical direction;
a second bent extension part extending from a rear end of the first bent extension part towards the first side of the motor body in such a way as to be parallel to the first extension part; and
a third bent extension part extending from a rear end of the second bent extension part towards the first side of the motor body in such a way as to be inclined downwards.

7. The terminal as set forth in claim 1, wherein the second extension part comprises:
a first bent extension part extending from a rear end of the bent part towards the first side of the motor body in such a way as to be inclined downwards;
a second bent extension part extending from a rear end of the first bent extension part towards the first side of the motor body in such a way as to be parallel to the first extension part; and
a third bent extension part extending from a rear end of the second bent extension part towards the first side of the motor body in such a way as to be inclined downwards at an inclination angle which is different from that of the first bent extension part.
